(19) United States
(12) Patent Application Publication
(10) Pub. No.: US 2015/0007960 A1
(43) Pub. Date: Jan. 8, 2015

(54) Column Buffer Thermal Energy Storage

(71) Applicant: Kegan Nobuyshi Kawano, Rockford, MI (US)

(72) Inventor: Kegan Nobuyshi Kawano, Rockford, MI (US)

(21) Appl. No.: 14/322,783

(22) Filed: Jul. 2, 2014

Related U.S. Application Data
(60) Provisional application No. 61/842,046, filed on Jul. 2, 2013.

(51) Int. Cl. F24J 3/08; H02K 7/18; E21D 5/01

(52) U.S. Cl. CPC F24J 3/086; E21D 5/01; H02K 7/1815; F24J 2003/088
USPC 165/45; 165/104.31; 405/55; 290/1 R

(57) ABSTRACT

A system for storing thermal energy includes an opening into the earth, a liner positioned within and surrounding an interior periphery of the opening, a liquid provided within the liner, a first conduit fluidly associated with an upper portion of the opening, a second conduit fluidly associated with a lower portion of the opening, a fluid movement device and a heat transfer device. The fluid movement device is fluidly connected between the first and second conduits and configured to transport liquid between the first and second conduits. The heat transfer device is fluidly connected to the first conduit and the second conduit and configured to transfer heat to or from the liquid.

### CROSS-REFERENCE TO RELATED APPLICATIONS

This application claims priority to U.S. Provisional Patent Application Ser. No. 61/842,046, filed Jul. 2, 2013, which is incorporated herein by reference.

### FIELD OF THE INVENTION

The invention is in the field of thermal energy and, in particular systems, for storing thermal energy.

### BACKGROUND OF THE INVENTION

Thermal energy storage for regulating the temperature of interior building environments includes many diverse technologies. The following is a partial list of the prior art thermal energy storage technologies and a subset of shortcomings of each item on the list. It will be obvious to those with ordinary skill in the art that each list item has many more shortcomings so, for brevity, only a few shortcomings are listed. Other advantages of the present invention over the prior art also will be rendered evident in the detailed description below.

Hand dug wells are structures dug in the earth to access groundwater. They do not store temperature differences, are not designed to have tight thermal coupling with the surrounding earth, are not watertight and are not designed to resist water pressure when completely filled with liquid.

Passive Solar Architecture is the practice of designing buildings to efficiently use solar energy. Generally, these buildings are designed to store heat from the day for use at night. This approach cannot be retrofitted to existing buildings without rebuilding. The existing Passive Annual Heat Storage (PAHS) approach does store heat between seasons, but cannot be retrofitted to an existing building.

Exchange using pressurized insulated tubing is a set of widely used technologies that store or retrieve heat from the earth often in combination with a heat pump. Although these technologies do store temperature differences across seasons, they are not generally used for active storage across seasons. Cross-linked polyethylene (PEX) tubing containing a water/antifreeze mixture is most typically used. The circulating fluid exchanges heat with the surrounding earth. At minimum, these technologies all suffer the disadvantage that PEX tubing is thermally insulative and retards heat exchange with the surroundings. This requires larger and more costly installations for the same thermal capacity. Leaks in the pressurized tubing can damage the heat pump and the environment, are very costly, disruptive, and time consuming to repair.

Trench with buried loop technologies involve a trench in the earth and buried PEX tubing. Because the trenches are dug around 6 feet deep, stored heat or cool will travel to the surface and be lost before it is needed in the opposite season. Large open surface areas are required to install the long trenches, so this is generally not an option in urban areas. Much disruption is done to the surface because of the trench and the trenching machinery. Tubes are run in parallel or helical configurations causing reduced efficiency due to parasitic heat leakage between parallel tubes or points where helical coils cross each other. Trenching and then filling uncompacts soil causes soil sinking which is mitigated with soil berms to combat soil sinking. In both cases, a long period of time occurs where soil heat capacity and conductivity are reduced due to uncompacted soil.

Vertical and radial boreholes are holes that are bored vertically (e.g. Borehole Thermal Energy Storage (BTES)) or off-vertically with tubing inserted and then backfilled with thermal grout. There are two tube configurations: U-tube and annular tube.

U-Tube configuration includes a continuous PEX tube that is inserted into the bored hole forming a U-shape. Because the bored hole is often 6 inches in diameter and filled with thermal grout, heat is transferred between the “up” and “down” legs of the U-shape. This parasitic heat loss reduces efficiency of heat transfer with the ground.

Annular tube configuration includes a tube within a tube where liquid travels one direction within the inner tube and the opposite direction in the outer tube. The inner tube is insulated. Heat exchange with the earth occurs in the outer tube. The annular tube configuration requires specialized and more costly tubing with specialized end to transfer liquid between the inner and outer tubes. The annular tube configuration requires substantial insulation of the inner tube to resist loss of efficiency due to parasitic heat transfer between the inner and outer tubes.

Thermal pilings are building pilings designed with integrated PEX tubing. They cannot be practically retrofit to existing buildings as pilings are integral to building engineering. Additionally, thermal pilings are nearly impossible to repair tubing leaks as pilings support building.

Pond, lake or ocean-based solutions include PEX tubing that is run through a relatively large body of water for heat exchange. These solutions are limited to environments proximate to a large body of water and may have ecological effects by changing temperature of the body of water. Leaks in tubing may have ecological effects due to harmful components of heat exchange fluid.

Direct exchange using pressurized conductive tubing includes boring vertical or radial boreholes and inserting refrigerant tubes (often of copper) and then backfilling the bores with thermal grout. Refrigerant is circulated directly within the tubes. Refrigerant tubes are costly. Leaks in the tubes are very damaging to the heat pump and the environment, and very costly, disruptive and time consuming to repair. Tubing material (usually copper) is much less resistant to corrosion than PEX. Anti-corrosion coatings often reduce thermal conductivity, making heat transfer to earth less efficient.

In an open loop thermal exchange system, liquid such as water is transferred between a relatively large body and the heat exchanger. The tubing is not pressurized, other than by the flow of liquid.

In an aquifer thermal energy storage (ATES) system, water is withdrawn, heat exchanged and then water returned to an aquifer. ATES requires proximity to an aquifer. The aquifer must not have significant water movement or stored heat/coolness will be lost. ATES is not thermally nor cost efficient on an individual, residential scale.

In a pit thermal energy storage (PTES) system, large, waterproof pits or caverns are used to store water. PTES requires proximity to a waterproof cavern or construction of a large, expensive waterproof pit. Cavern usage requires extensive geology and hydrologic study. The volume to surface area ratio requirements for PTES favors large projects, and is consequently very costly on an individual, residential scale.

A pervious concrete pit storage system includes a waterproof pit created and filled with water-pervious concrete and is costly due to the concrete required to fill the pit. Limited water thermal stratification reduces heat exchange efficiency due to interference of pervious concrete. The pervious pit storage system has reduced thermal storage capacity per unit volume. Higher thermal capacity water is displaced by lower thermal capacity pervious concrete within the volume. The solution requires increased pumping power to move water through pervious concrete as compared with a storage volume containing water only.

In a tank thermal energy storage (TTES) system heat/cool is exchanged with water stored in a large, insulated tank. TTES requires a high cost to construct a large, insulated tank. The volume to surface area ratio requirements favor large projects and are consequently very costly on an individual, residential scale. The tank size limits ability for retrofitting building with TTES.

A standing column well is a well that is bored to great depths mostly through bedrock and well into groundwater. The bedrock forms a column semi-pervious to groundwater. An insulated tube conveys water to and from the bottom of the column. A standing column requires short boring depth to bedrock for cost effectiveness thus limiting potential locations. Additionally, a standing column well requires groundwater and is vulnerable to moving groundwater that may cause loss of stored heat/cool and to fouling due to minerals/bacteria in the groundwater.

Pit thermal energy storage (PTES) via a hybrid pit/borehole is a pit horizontally surrounded by a set of vertical boreholes with the boreholes used to capture heat lost from the pit. PTES via a hybrid pit/borehole suffers all the disadvantages of both the PTES and vertical borehole approaches and includes extra cost and difficulty due to requiring coordination of construction experience and technology for both pit construction and borehole drilling. The technology potentially requires extra cost of heat pump heat exchange coils for dissolved oxygen (pit liquid) and non-dissolved oxygen (heat exchange liquid from borehole PEX tubing) and requires separate pumping and control systems for differing pit and borehole regimes. The complexity of construction and control favor large projects due to economies of scale and is consequently difficult to make cost effective on an individual, residential scale.

In hybrid tank/BTES field technology, a TTES tank is used to buffer thermal energy when required heat transfer is greater than the borehole system can accommodate. This hybrid approach suffers all the disadvantages of both the TTES and BTES approaches and incurs extra cost and difficulty due to requiring coordination of construction experience and technology for both tank construction and borehole drilling. The approach requires separate pumping and control systems for differing tank and borehole regimes and the complexity of construction and control favor large projects due to economies of scale and is consequently difficult to make cost effective on an individual, residential scale.

No single apparatus or technique in the prior art provides all of the benefits as well as the present invention described herein.

### BRIEF DESCRIPTION OF THE INVENTION

The invention relates to a method and apparatus to store heat or coolness in both water and earth using a column of water in the earth where the column has sufficient volumetric liquid thermal capacity to provide daily storage, sufficient daily heat exchange with the earth and accesses sufficient earth thermal capacity to provide storage until the opposite season.

In one aspect, the invention relates to a system for storing thermal energy. The system includes a least one opening into the earth having an axis and a columnar shape. A liner is positioned within and surrounding an interior periphery of the at least one opening. The liner has a leak-proof characteristic and interfaces directly with the earth to allow direct thermal transfer. A liquid is provided within the liner and occupies at least a majority of the volume of an interior of the liner. A first conduit is fluidly associated with an upper portion of the at least one opening for delivering or withdrawing liquid to the opening adjacent the upper portion of the at least one opening. A second conduit is fluidly associated with a lower portion of the opening for delivering or withdrawing liquid to the opening adjacent the lower portion of the opening. A fluid movement device and a heat transfer device are fluidly connected between the first conduit and the second conduit. The fluid movement device is configured to transport liquid between the first conduit and the second conduit. The heat transfer device is fluidly connected to the first conduit and the second conduit and configured to transfer heat to or from the liquid.

The axis of the at least one opening may generally perpendicular to a surface of the earth.

The system may be associated with a structure to which heat from the system is to be delivered to or withdrawn from.

The structure may be a building, a residence, an office building, an industrial center, a greenhouse, a bridge, a roadway, a driveway, a pool, an icemelt system, a hydronically heated floor or a sidewalk.

The liquid in the system may be water.

The liner may cover the sides and bottom of the at least one opening. The liner may be formed from at least one of concrete, shotcrete, gunite, underwater-curable concrete. The liner may be reinforced by spirally-wrapped twine.

The system may include a plurality of baffles spaced vertically along the axis of the at least one opening. Each of the plurality of baffles may comprise a body generally shaped to conform with the interior of the liner and define at least one passageway between a periphery of the baffle and the interior of the liner. The vertical spacing of the baffles may be regular. The periphery of each of the plurality of baffles may be crenelated. The second conduit of the system may extend downwardly into the at least one opening from the upper portion thereof, in general register with a central portion thereof and through a central opening in each of the baffles.

The bottom of the second conduit may be fluidically connected to at least one laterally extending conduit which has at least one distal opening allowing the liquid being delivered or withdrawn from the distal opening to be delivered or withdrawn so as to induce rotation of the liquid reservoir about the axis of the at least one opening

The first and second conduits may be thermally insulated.

The at least one heat transfer device may include at least one one-way heat transfer device configured to transport heat upwardly to an external heat exchanger.

The system may further include an embodiment wherein the first conduit is fluidly interconnected with the second conduit to form a closed loop within the at least one opening. The fluid movement contained by the first and the second conduits may be contained within a common housing.

The system may further include a generator operably connected to the fluid passing through the heat exchanger to generate electricity from the liquid in the system via at least one of the Organic Rankine cycle, the Kalina cycle or the Stirling engine.

The at least one fluid movement device and the at least one heat transfer device may be contained within a common device housing.

In another aspect, the invention relates to a method of installing a system for storing thermal energy. The method comprises the steps of: excavating an opening having a column shape and an axis into the earth; installing a leak-proof liner around an interior periphery of the opening; filling the at least one opening with a liquid; plumbing a first conduit to withdraw or deliver liquid to an upper portion of the opening; plumbing a second conduit to withdraw or deliver liquid to a lower portion of the opening; positioning a series of baffles along the axis of the opening so that liquid can flow around a peripheral portion of each baffle adjacent the interior of the liner; and fluidly interconnecting remote ends of the first and second conduits to a fluid movement device and a heat transfer device to allow for heating, cooling and flow of the liquid in the at least one opening between the upper and lower portions thereof.

The liner may be extended at pace with the excavation using shotcrete or gunite to allow the liner to be leak-proof, interfaced directly with the earth to allow direct thermal transfer and to provide safety protection from cave-in while excavating.

In yet another aspect, the invention relates to a method for storing thermal energy, the method comprises the steps of: providing at least one opening into the earth having an axis and a columnar shape; lining an interior periphery and bottom of the at least one opening with a leak-proof material; filling the interior of the at least one opening with liquid; withdrawing liquid from one of the upper portion or the lower portion of the at least one opening; using the withdrawn liquid to exchange heat; and returning the withdrawn liquid to the other of the upper portion or the lower portion of the at least one opening.

### BRIEF DESCRIPTION OF THE DRAWINGS

In the drawings:

FIG. 1 illustrates a column buffered thermal energy storage system.

FIG. 2 illustrates a column buffered thermal energy storage system with pipes.

FIG. 3 illustrates a perspective axial view from the top of an empty column buffered thermal energy storage system.

FIG. 4 illustrates a water-filled column buffered thermal energy storage system retrofitted to a building with an insulated pipe.

FIG. 5 illustrates a column buffered thermal energy storage system with discrete heat stratification baffles.

FIG. 6 illustrates heat stratification baffles attached to an insulated pipe with swirling discharge pipes.

FIG. 7 illustrates a column buffered thermal energy storage system with an insulated inner surface at the top section of the column.

FIG. 8 illustrates a column buffered thermal energy storage system with two vertical columns coupled by a horizontal column beneath a building.

FIG. 9 illustrates a linear arrangement of multiple vertical columns of a column buffered thermal energy storage system.

FIG. 10 illustrates a concentric arrangement of multiple vertical columns of a column buffered thermal energy storage.

FIG. 11 illustrates a manual excavation of a column of a column buffered thermal energy storage system inside of a building.

FIG. 12 illustrates a manual application of underwater concrete to the bottom of a column of a column buffered thermal energy storage system.

FIG. 13 illustrates filling a column of a column buffered thermal energy storage system with liquid while the underwater concrete column bottom is not cured.

FIG. 14 illustrates a spiral application of concrete-reinforcing basalt twine to the surface of a column of a column buffered thermal energy storage system.

FIG. 15 illustrates a column buffered thermal energy storage system that includes a solar panel and a water-air heat pump.

FIG. 16 illustrates a column buffered thermal energy storage system that includes a greenhouse and a water-air heat pump.

FIG. 17 illustrates a column buffered thermal energy storage system that includes a greenhouse, a heat pump and an above-ground insulated tank.

FIG. 18 illustrates a column buffered thermal energy storage system that includes a solar panel, a heat pump and an electrical generator.

FIG. 19 illustrates a column buffered thermal energy storage system that includes a solar panel and a hydronic floor.

FIG. 20 illustrates a column buffered thermal energy storage system according to the invention.

### DESCRIPTION OF EMBODIMENTS OF THE INVENTION

Previous approaches to thermal energy storage have taken one of two general approaches or a hybrid thereof. The first approach is to store energy in soil by maximizing the soil surface area exposed to heat exchange by a heat exchange fluid. This approach generally takes the form of heat exchange fluid circulated through long tubes. The second approach is to store heat in a large reservoir of heat exchange fluid. This approach generally consist of trying to get the heat exchange storage volume as close as possible to a sphere to maximize the volume:surface area ratio and keep as much heat/cool within the large reservoir.

The present invention takes a third approach in which a significant volume of heat exchange fluid is stored in a reservoir that maximizes both the heat exchange capacity and heat exchange fluid volume while realizing a significant number of other advantages. The present invention provides methods and systems for storing thermal energy. The present invention will be described in terms of particular systems and particular components. However, one of skill in the art will readily recognize that these methods and systems will operate effectively for other components in heating and cooling systems. The present invention will be described in the context of components that embody features of the invention. However, one of skill in the art will readily recognize that the present invention, while described through the embodiments presented herein, is not intended to be limited to the embodiments shown, but is to be accorded the widest scope consistent with the principles and features described herein. It is contemplated that the present disclosure encompasses at least the following inventive concepts:

A system for storing thermal energy includes at least one opening into the earth having an axis and a columnar shape. A liner is positioned within and surrounding an interior periphery of the at least one opening. The liner has a leak-proof characteristic and interfaces directly with the earth to allow direct thermal transfer. A liquid is provided within the liner and occupies at least a majority of the volume of an interior of the liner. A first conduit is fluidly associated with an upper portion of the at least one opening for delivering or withdrawing liquid to the opening adjacent the upper portion of the at least one opening. A second conduit is fluidly associated with a lower portion of the opening for delivering or withdrawing liquid to the opening adjacent the lower portion of the opening. A fluid movement device and a heat transfer device are fluidly connected between the first conduit and the second conduit. The fluid movement device is configured to transport liquid between the first conduit and the second conduit. The heat transfer device is fluidly connected to the first conduit and the second conduit and configured to transfer heat to or from the liquid.

The axis of the at least one opening may generally perpendicular to a surface of the earth.

The system may be associated with a structure to which heat from the system is to be delivered to or withdrawn from.

The structure may be a building, a residence, an office building, an industrial center, a greenhouse, a bridge, a roadway, a driveway, a pool, an icemelt system, a hydronically heated floor or a sidewalk.

The liquid in the system may be water.

The liner may cover the sides and bottom of the at least one opening. The liner may be formed from at least one of concrete, shotcrete, gunite, underwater-curable concrete. The liner may be reinforced by spirally-wrapped twine.

The system may include a plurality of baffles spaced vertically along the axis of the at least one opening. Each of the plurality of baffles may comprise a body generally shaped to conform with the interior of the liner and define at least one passageway between a periphery of the baffle and the interior of the liner. The vertical spacing of the baffles may be regular. The periphery of each of the plurality of baffles may be crenelated. The second conduit of the system may extend downwardly into the at least one opening from the upper portion thereof, in general register with a central portion thereof and through a central opening in each of the baffles.

The bottom of the second conduit may be fluidically connected to at least one laterally extending conduit which has at least one distal opening allowing the liquid being delivered or withdrawn from the distal opening to be delivered or withdrawn so as to induce rotation of the liquid reservoir about the axis of the at least one opening

The first and second conduits may be thermally insulated.

The at least one heat transfer device may include at least one one-way heat transfer device configured to transport heat upwardly to an external heat exchanger.

The system may further include an embodiment wherein the first conduit is fluidly interconnected with the second conduit to form a closed loop within the at least one opening. The fluid movement contained by the first and the second conduits may be contained within a common housing.

The system may further include a generator operably connected to the fluid passing through the heat exchanger to generate electricity from the liquid in the system via at least one of the Organic Rankine cycle, the Kalina cycle or the Stirling engine.

The at least one fluid movement device and the at least one heat transfer device may be contained within a common device housing.

A method of installing a system for storing thermal energy. The method comprises the steps of: excavating an opening having a column shape and an axis into the earth; installing a leak-proof liner around an interior periphery of the opening; filling the at least one opening with a liquid; plumbing a first conduit to withdraw or deliver liquid to an upper portion of the opening; plumbing a second conduit to withdraw or deliver liquid to a lower portion of the opening; and fluidly interconnecting remote ends of the first and second conduits to a fluid movement device and a heat transfer device to allow for heating, cooling and flow of the liquid in the at least one opening between the upper and lower portions thereof.

The method may further include a step of positioning a series of baffles along the axis of the opening so that liquid can flow around a peripheral portion of each baffle adjacent the interior of the liner.

A method for storing thermal energy includes the steps of: providing at least one opening into the earth having an axis and a columnar shape; lining an interior periphery and bottom of the at least one opening with a leak-proof material; filling the interior of the at least one opening with liquid; withdrawing liquid from one of the upper portion or the lower portion of the at least one opening; using the withdrawn liquid to exchange heat; and returning the withdrawn liquid to the other of the upper portion or the lower portion of the at least one opening.

A method of installing a system for storing thermal energy includes the steps of: excavating an opening having a column shape and an axis into the earth; installing a leak-proof liner around an interior periphery of the opening; filling the at least one opening with a liquid; plumbing a first conduit to withdraw or deliver liquid to an upper portion of the opening; plumbing a second conduit to withdraw or deliver liquid to a lower portion of the opening; and fluidly interconnecting remote ends of the first and second conduits to a fluid movement device and a heat transfer device to allow for heating, cooling and flow of the liquid in the at least one opening between the upper and lower portions thereof. The liner may be extended at pace with the excavation using shotcrete or gunite to allow the liner to be leak-proof, interfaced directly with the earth to allow direct thermal transfer and to provide safety protection from cave-in while excavating.

The method may further include a step of positioning a series of baffles along the axis of the opening so that liquid can flow around a peripheral portion of each baffle adjacent the interior of the liner.

A method for storing thermal energy includes steps of: providing at least one opening into the earth having an axis and a columnar shape; lining an interior periphery and bottom of the at least one opening with a leak-proof material; filling the interior of the at least one opening with liquid; withdrawing liquid from one of the upper portion or the lower portion of the at least one opening; using the withdrawn liquid to exchange heat; and returning the withdrawn liquid to the other of the upper portion or the lower portion of the at least one opening.

As used herein, the term “column” means an elongate member having a longitudinal axis and defining a longitudinal cross-section resembling any closed shape such as, for example, a circle, a non-circle such as an oval (which generally can include a shape that is substantially in the form of an obround, ellipse, limaçon, cardioid, cartesian oval, and/or Cassini oval, etc), and/or a polygon such as a triangle, rectangle, square, hexagon, the shape of the letter “D”, the shape of the letter “P”, etc. Thus, a right circular cylinder is one form of a column, an elliptic cylinder is another form of a column having an elliptical longitudinal cross-section, and a generalized cylinder is yet another form of a column.

It is understood that elements of the various embodiments here described may be combined without the need to specify every combination specifically.

This section outlines a first embodiment of the invention.

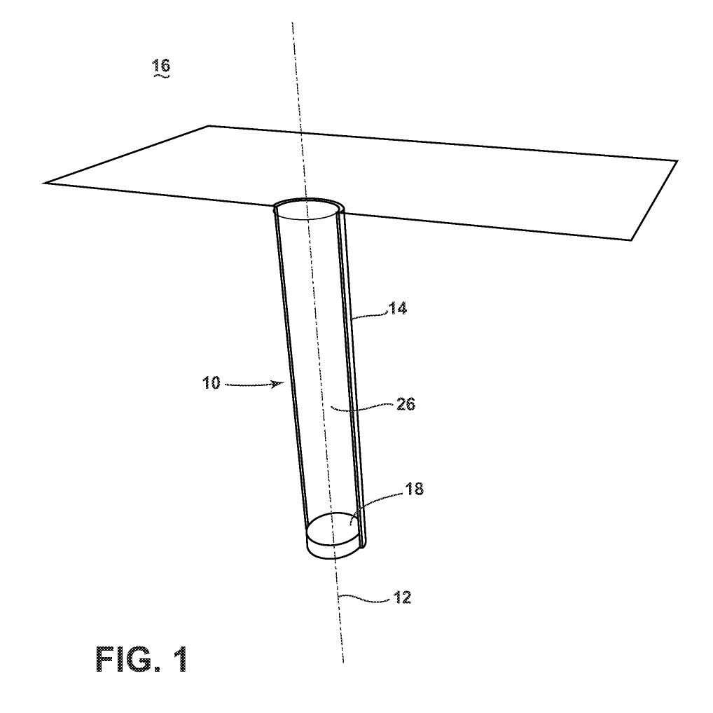

This embodiment describes a waterproof column 10 excavated into the earth as show in FIG. 1. As per the previous definition of a column, columns of many shapes are possible. Columns which change shape as one proceeds along the axis 12 are also possible. This preferred embodiment describes a column 10 which is a cylinder while not excluding other shapes previously described. The cylinder is preferred as the circular cross section provides the greatest hoop strength against both inward and outward forces. Additionally, the circular cross section allows the use of centrifugally cast concrete application technology to easily form cylindrical walls 14 strongly mated to the excavated earth walls. The circular cross section also allows the strongest geometry when placing reinforcing materials like basalt twine that reinforce against forces acting outwards on the column walls 14.

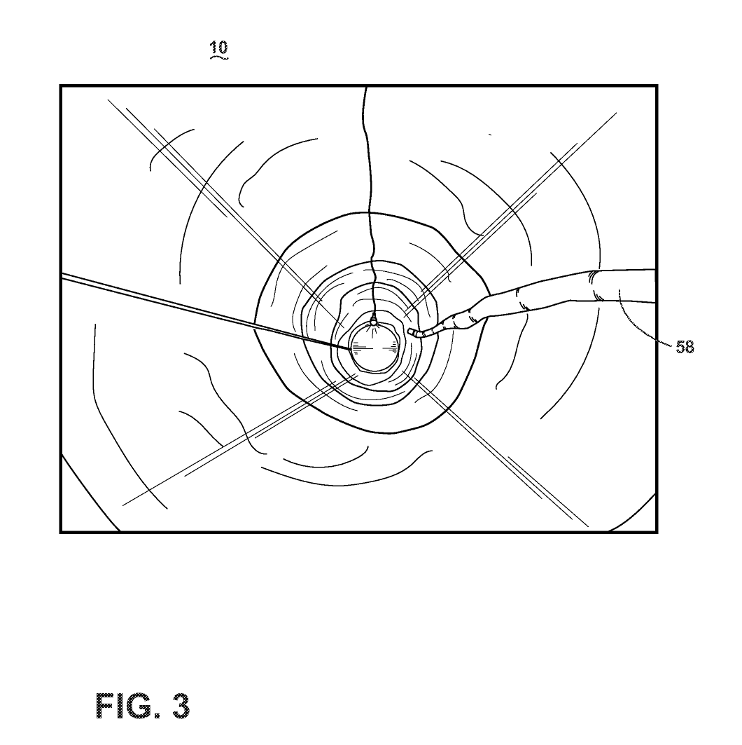

The inner diameter of the column 10 shown in FIG. 1 may range from 4″ to 240″. Diameters below 4″ make for difficult construction, difficult insulated tube insertion and low buffer volume compared to diameters within the stated range. Diameters above 240″ have greater construction material costs and lower heat exchange area per heat exchange fluid volume when compared to diameters within the stated range. Determining the optimum diameter is a function of the soil profile with depth, difficulty of excavation, thermal conductivity, thermal capacitance, soil moisture, variability of heat exchange requirements, length of heat exchange periods, magnitude of heat storage, cost of available excavation methods, depth to groundwater, size of building, strength of available wall and bottom material and other factors. In many instances, a diameter of 42″ provides an optimum balance when considering all these factors especially in that 42″ allows for manual excavation, construction, repair and the use of technology from well construction, water pipe installation, manhole construction and manhole rehabilitation. As a non-limiting example, FIG. 3 shows a 42″ diameter unfilled column 10. A 42″ diameter is the preferred embodiment while not excluding other diameters previously described.

The column wall 14 material as shown in FIG. 1 may be made of many heat conducting materials including, but not limited to metal, heat conducting epoxies, sulphur enhanced concrete, shotcrete, gunite, underwater concrete and the many other compositions of concrete. The preferred embodiment is gunite concrete as it has numerous benefits in application, has sufficient strength and sufficient waterproofness. Gunite also comes with a large amount of knowledge and technology developed in the use of recreational pool construction. This preferred material embodiment does not exclude the other materials previously described.

The column depth as shown in FIG. 1 is a function of the soil profile with depth, difficulty of excavation, thermal conductivity, thermal capacitance, soil moisture, variability of heat exchange requirements, length of heat exchange periods, magnitude of heat storage, cost of available excavation methods, depth to groundwater, size of building, strength of available wall and bottom material and other factors. The incremental cost and effort of adding an additional foot to the depth of the column 10 is very low. The preferred embodiment of the column depth is greater than 20 feet (the units of feet herein abbreviated with the apostrophe ′) since as a general rule heat travels about 20′ in 6 months through the soil. Heat transferred to soil below 20′ is generally available 6 months later when heat is being removed from the soil. When the system 16 is in balance over the year, the amount of heat added to the soil will be the same as the amount removed. The soil heat distribution created when heat is added will reverse itself when heat is being removed. As long as heat/cool is not lost to the atmosphere or moving ground water, it will be mostly available in the opposite season.

The column bottom material 18 as shown in FIG. 1 may be made of many heat conducting materials including, but not limited to metal, heat conducting epoxies, sulphur enhanced concrete, shotcrete, gunite, underwater concrete and the many other compositions of concrete. The preferred embodiment material is underwater concrete as it has numerous benefits in construction, has sufficient strength and sufficient waterproofness. Underwater concrete comes with a large amount of knowledge and technology developed in the pouring of concrete in underwater applications. This preferred material embodiment does not exclude the other materials previously described.

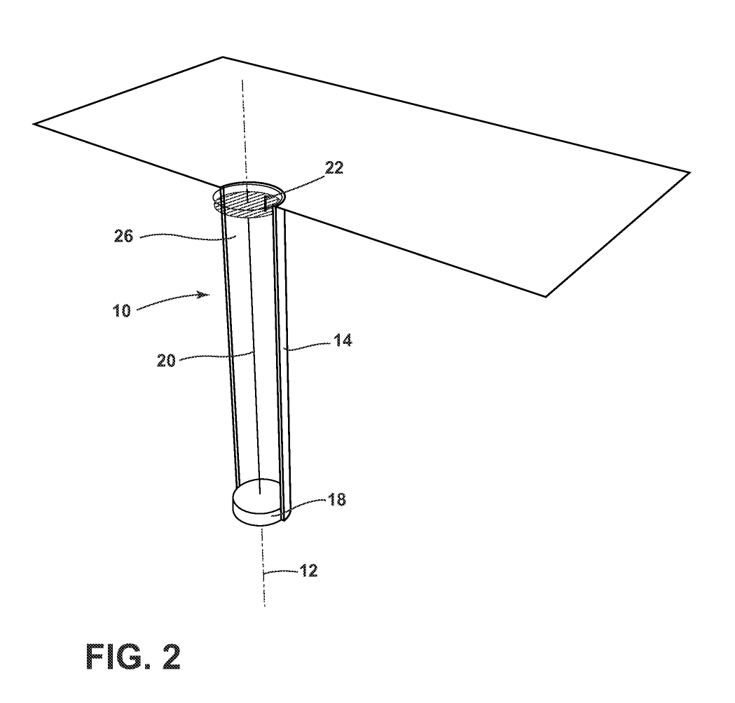

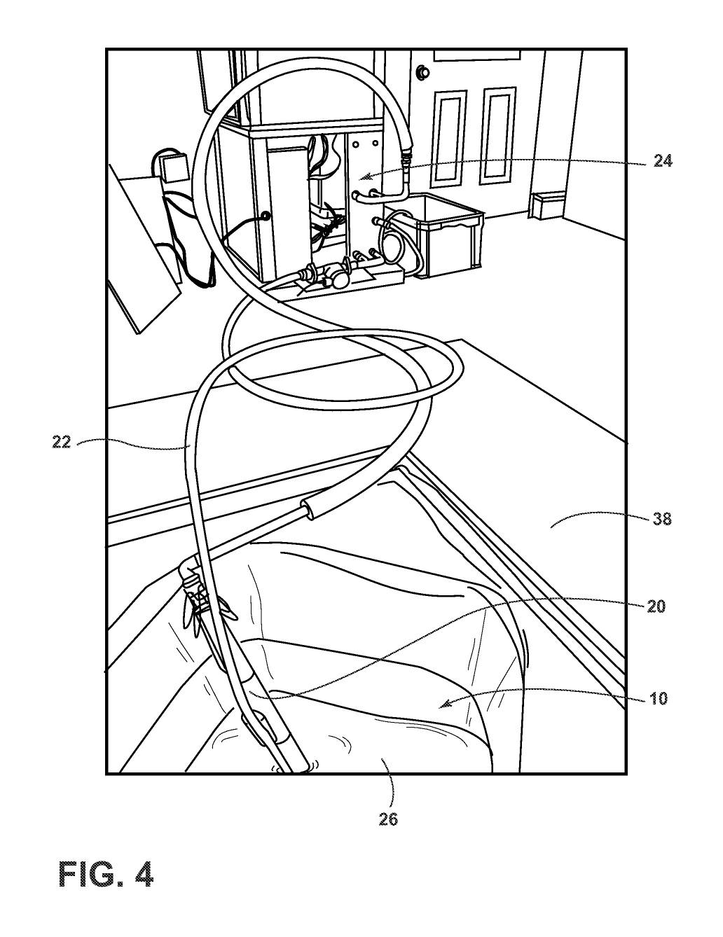

The insulated pipe 20 to bottom as shown in FIG. 2 may be made of many pipe materials including, but not limited to PVC, CPVC, PEX, ABS, plastic, metal, and ceramic. The preferred embodiment material is CPVC as it is readily available, inexpensive, tolerates high temperatures, resists the movement of heat through its walls, is rigid and is easily cut and joined. This preferred material embodiment does not exclude the other materials previously described. The pipe 20 to the bottom transports liquid from an external heat or cool source to or from the bottom of the column. As a non-limiting example, FIG. 4 shows the pipe to top 22 and insulated pipe to bottom 20 connected to a water-to-air heat pump 24.

As shown in FIG. 4, the preferred embodiment direction of liquid circulation is down the insulated pipe to bottom 20 with liquid returned to the external heat or cool source via the pipe to top 22. When heat is injected into the column 10, the hottest liquid will reside at the bottom and provide the most earth heating. The further the heat is kept from the surface, the less heat will leak to the atmosphere. When cool is injected into the column, the cool liquid will exchange heat with the hottest portion of the column 10 (i.e. the bottom). Additionally, thermal stratification will naturally occur, allowing the pipe to top 22 to harvest warmer liquid. Injected cool into the bottom rather than top of the column enhances the thermal stratification. This preferred embodiment of liquid direction does not exclude the other direction of liquid travel.

The insulation surrounding the pipe to bottom 20 as shown in FIGS. 2 and 4 may be made of many waterproof, insulative materials including, but not limited to bubble wrap, EPS foam, XPS foam, polyplank and neoprene. The preferred embodiment material is neoprene as it is commonly available, flexible and has a long track record of providing insulation in water. When installing the pipe to bottom 20, the pipe will flex and the insulation must not be compromised during that flex. This preferred material embodiment does not exclude the other materials previously described.

The thermal storage liquid 26 as shown in FIG. 1 may be composed of materials including, but not limited to water, water with antifreeze, phase change materials, water with antimicrobial additives etc. The preferred embodiment material is water as it is very cost effective, available, safe, has sufficient thermal capacity, and remains a liquid within the range of soil temperatures. The preferred material embodiment does not exclude the other materials as previously described.

The top of the column 10 is covered with a moisture-proof cover having significant insulative value that allows passage of the pipe to bottom 20 and pipe to top 22.

This section outlines a second embodiment of the invention.

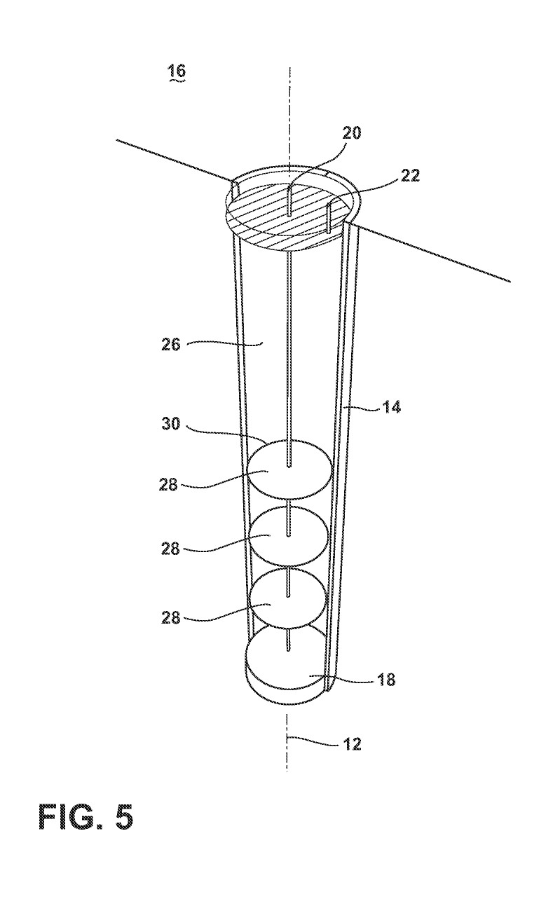

This embodiment contains all the elements of the first embodiment, but adds a series of heat stratification baffles 28 as shown in FIG. 5. The baffles 28 are constructed to be several inches smaller in diameter than the column diameter allowing a space for liquid 26 to pass between the baffle edge 30 and the column's inner surface. Due to fluid properties, a slow moving liquid film will form on the interface between the heat storage fluid 26 and the inner surface of the column walls 14. Warm fluid will tend to rise, but, all else being equal, will rise through the central axis 12 of the column 10. The heat stratification baffles 28 force this rising water past the inner surface of the column walls 14, increasing heat transfer by increased temperature and forced mixing of the liquid film. The baffles 28 may be made of many rigid, waterproof materials including, but not limited to corrugated plastic sheet, plastic, metal, and wood. The preferred embodiment material is corrugated plastic sheet as it is very cost effective, easy to work with and very water resistant. The preferred material embodiment does not exclude the other materials as previously described. The baffles 28 are attached to the insulated pipe to bottom 20. The number and spacing of the baffles 28 are very dependent on soil profile with depth, difficulty of excavation, thermal conductivity, thermal capacitance, soil moisture, variability of heat exchange requirements, length of heat exchange periods, magnitude of heat storage, cost of available excavation methods, depth to groundwater, size of building, strength of available wall and bottom material and other factors. Baffles 28 may be spaced from 6″ to 240″ apart. The preferred embodiment in a large number of cases is to space the baffles 28 every 4′ to within 4′ of the top of the column. The preferred spacing embodiment does not exclude other spacings as previously described.

This section outlines a third embodiment of the invention.

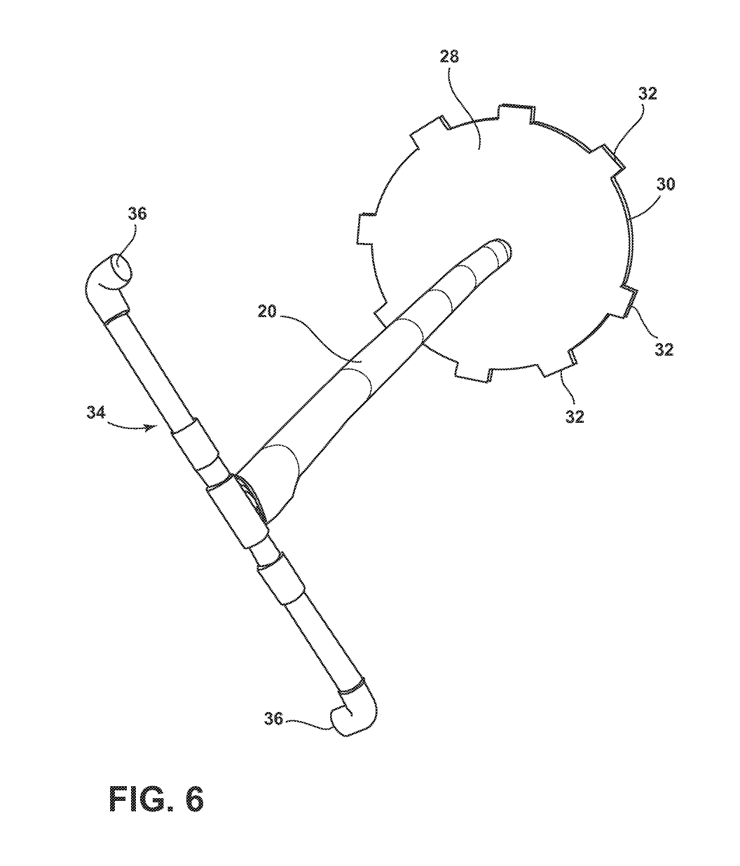

This embodiment contains all the elements of the second embodiment, but adds spacers 32 to the outer edges 30 of the heat stratification baffles 28 as shown in FIG. 6. The spacers 32 keep the baffles 28 from occluding liquid movement from a large section of one side of the column as may happen when the baffles 28 rest on that side. Occluded sections will have lower heat transfer due to lower fluid movement. The spacers 32 greatly reduce the occlusion. Spacers 32 may be formed from, but not limited to notches in the baffle material and material inserted in the edges 30 of the baffles 28. The preferred embodiment of spacer formation is notches in the baffle material is this is simplest and reduces manufacturing time. The preferred spacer formation embodiment does not exclude other spacer formations as previously described.

This section outlines a fourth embodiment of the invention.

This embodiment contains all the elements of the first embodiment, but adds swirling discharge pipes 34 to the bottom of the pipe to bottom as shown in FIG. 6. The swirling discharge pipes 34 serve to prevent occlusion of the exit orifice 36 of the pipe to bottom 20 and to increase heat transfer by creating a swirling effect. Liquid exiting (or entering) the swirling discharge pipes 34 is made to move along the circumference of the column thereby increasing temperature difference and breaking up the liquid film. The preferred embodiment orientation of the swirling discharge pipes 34 is to orient the discharge to assist the Coriolis effect per earth hemisphere in which the apparatus is being installed. This preferred embodiment does not exclude the opposite orientation.

This section outlines a fifth embodiment of the invention.

This embodiment contains all the elements of the first embodiment, but adds spiraling heat stratification baffles centered around the insulated pipe to bottom. These baffles serve the same purpose as the heat stratification baffles in the second embodiment. Rather than discrete baffles a continuous spiral rises from 1″ to 120″ from the bottom of the column to 1″ to 120″ from the top. The preferred starting distance from the bottom is 12″ and the preferred stopping distance from the top of the column is 48″. These preferred distance embodiments do not exclude other distances as previously described.

The outer edge of the spiral is designed to fit as snugly as possible or is attached to the inner surface of the column. Liquid rising due to stratification or pumping forces is forced to take a much longer path and pass much more of the column inner surface thus increasing heat transfer. The pitch of the spiraling heat stratification baffle may vary between 1″ and 48″ between edges. The preferred baffle pitch is 12″. This preferred pitch embodiment does not exclude the other pitches as previously described.

This section outlines a sixth embodiment of the invention.

This embodiment contains all the elements of the first embodiment, but adds spiraling heat stratification baffles centered around the insulated pipe to bottom. These baffles serve the same purpose as the heat stratification baffles in the second embodiment. Rather than discrete baffles a continuous spiral rises from 1″ to 120″ from the bottom of the column to 1″ to 120″ from the top. The preferred starting distance from the bottom is 12″ and the preferred stopping distance from the top of the column is 48″. These preferred distance embodiments do not exclude other distances as previously described.

This section outlines a seventh embodiment of the invention.

This embodiment contains all the elements of the first embodiment, but places the apparatus under a building. When placing the apparatus under a building it may be started at any point connected to the earth, but the preferred location to place the apparatus is in a basement as the column starts at a lower point. This increases the distance that heat must travel through the earth to reach the atmosphere, reducing the amount of heat loss. As well, the placement of the apparatus under a building allows heat/cool that reaches the lower surface of the building to contribute to reducing energy usage. The preferred basement placement embodiment of the apparatus does not exclude other placements as previously described.

This section outlines an eighth embodiment of the invention.

This embodiment contains all the elements of the first embodiment, but adds floor insulation above and around the top of the column. By varying the insulative value from R0.1 to R30 and placement/amount of this insulation from 1 square foot to 1,000,000 square feet (meaning a very small surface to a very large surface), the rate of heat/cool return to the building from the earth can be controlled. The same applies if the column is installed outside of a building, but the insulation serves to reduce heat/cool lost to the environment. It is desirable to have heat enter the building when heating is needed and cool when cooling is needed. FIG. 4 shows a non-limiting example of insulation 38 being applied to the surface in which exists the top surface of the column 10. In the case of FIG. 4, heat is returning from the column 10 while cooling is still needed. The insulation 10 serves to retard the heat's return until the heat can serve to aid thermal regulation and reduce energy usage. The placement and thickness of insulation does not exclude other placements as previously described. Additionally, the insulative cover may be entirely removed to maximize heat transfer from the column and surrounding earth during periods when heat is desired in the building. Additionally, the building may be provided with various thicknesses and configurations of insulation to fit the various heat transfer desires within the building especially as related to seasonal temperatures.

This section outlines a ninth embodiment of the invention.

This embodiment contains all the elements of the first embodiment, but adds insulation to the top section of the inner surface of the column. By varying the insulative value from R0.1 to R30 and placement/amount of this insulation from the top 1′ to the top 20′, the rate of heat/cool return to the building from the earth can be controlled. It is desirable to have heat enter the building when heating is needed and cool when cooling is needed. The configuration of insulation is subject to variation of soil profile with depth, difficulty of excavation, thermal conductivity, thermal capacitance, soil moisture, variability of heat exchange requirements, length of heat exchange periods, magnitude of heat storage, cost of available excavation methods, depth to groundwater, size of building, strength of available wall and bottom material and other factors. A preferred embodiment is to apply R4 to the top 20′ of the column as heat generally moves 20′ in 6 months and R4 is sufficient to retard heat/cool until late enough to start reducing energy costs. The placement and thickness of insulation does not exclude other placements as previously described.

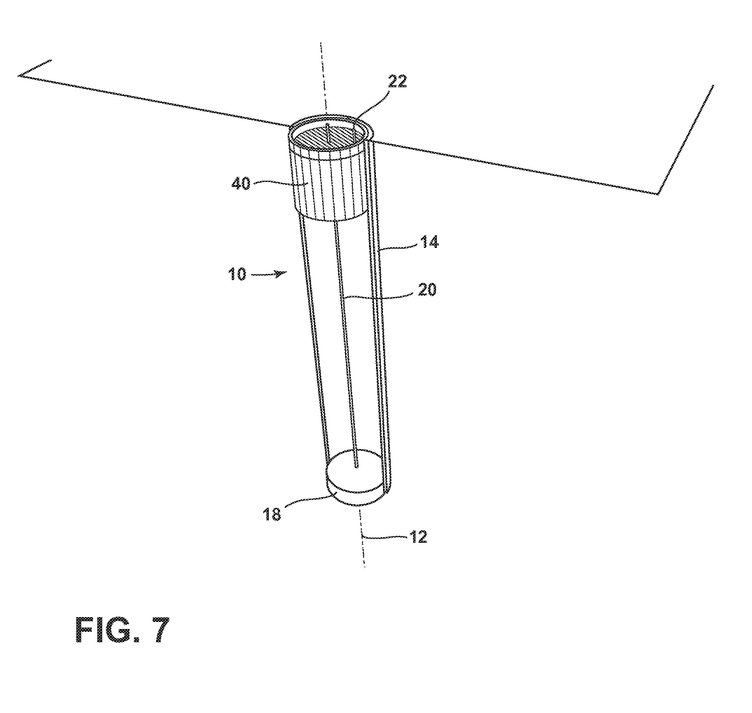

FIG. 7 shows a non-limiting example of insulation 40 being applied to the inner surface of the top section of the column 10. The insulation 40 serves to retard the heat's return until the heat can serve to aid thermal regulation and reduce energy usage. The placement and thickness of insulation does not exclude other placements as previously described.

This section outlines a tenth embodiment of the invention.

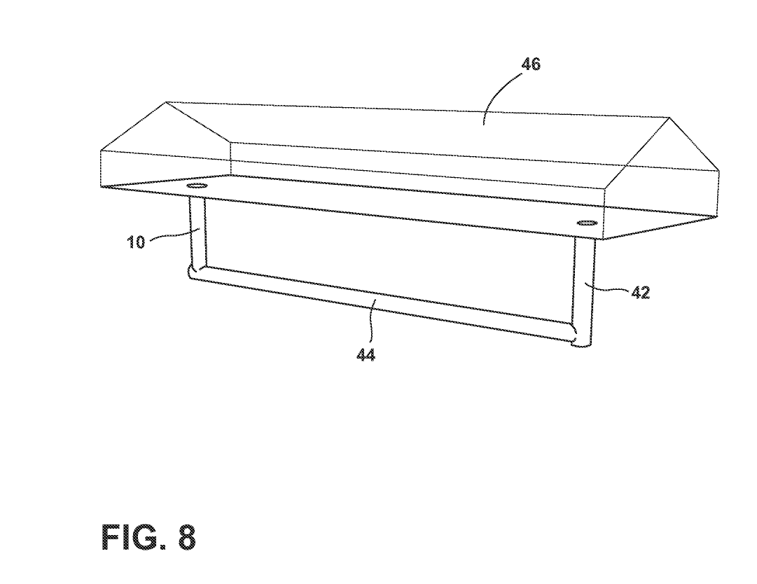

This embodiment contains all the elements of the first embodiment, but adds a second vertical column 42 and a connecting horizontal column 44. A non-limiting example is shown in FIG. 8. Another non-limiting example is the use of the horizontal column to connect multiple vertical columns. Heat storage liquid is injected into the top of one vertical column and removed from the top of the other. With this embodiment, pumping resistance is negligible as the heat storage liquid velocity in the columns becomes slow and the column diameters are large in comparison to most other pumping situations. By varying the depth of the horizontal column 44, the timing of heat return to the surface can be controlled. This embodiment is especially useful for, but not limited to long thin buildings 46 like greenhouses placed directly above and in line with the horizontal column 44. The horizontal column 44 is placed either by excavation or directional boring from the bottoms of the vertical columns 10, 42. The heat radiating from the horizontal column 44 is largely captured by the building 46 when the horizontal column 44 is placed at the preferred depth of 20′ depending on soil profile with depth, difficulty of excavation, thermal conductivity, thermal capacitance, soil moisture, variability of heat exchange requirements, length of heat exchange periods, magnitude of heat storage, cost of available excavation methods, depth to groundwater, size of building, strength of available wall and bottom material and other factors. The horizontal column 44 may be placed from a depth of 5′ to 100′, but the preferred depth of 20′ will tend to allow heat/cool to arrive in the building 46 when needed. The preferred depth embodiment does not exclude other depths as previously described.

This section outlines an eleventh embodiment of the invention.

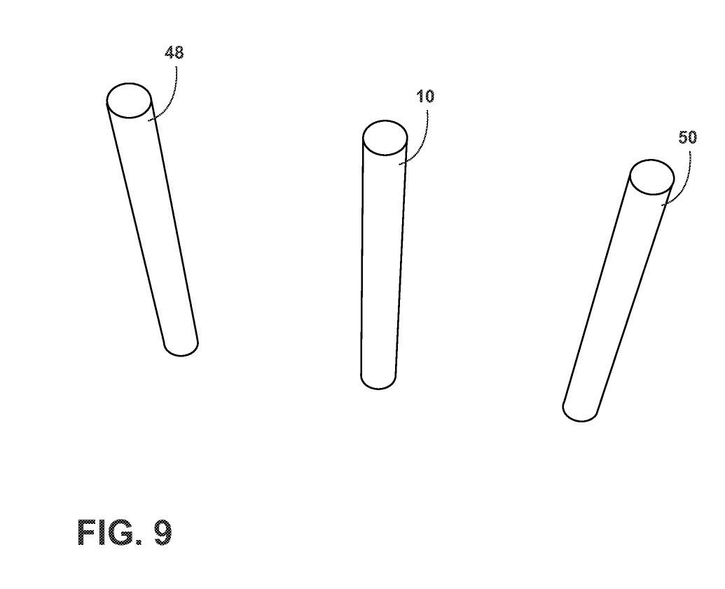

This embodiment contains all the elements of the first embodiment, but adds from 2 to a large number of additional vertical columns. FIG. 9 shows a non-limiting example of 3 columns 10, 48, 50. The columns 10, 48, 50 are connected either by having fluid flow from outer 48, 50 through inner columns 10 or fluid flow to each column 10, 48, 50 is controlled based on parameters like column temperature. The preferred embodiment is to have fluid flow from inner 10 to outer columns 48, 50 in the case of heat addition and from outer 48, 50 to inner columns 10 in the case of heat extraction. This embodiment is simpler, more cost effective and automatically returns the hottest or coldest fluid (as is desired). This preferred fluid flow embodiment does not exclude other fluid flow regimes.

This section outlines a twelfth embodiment of the invention.

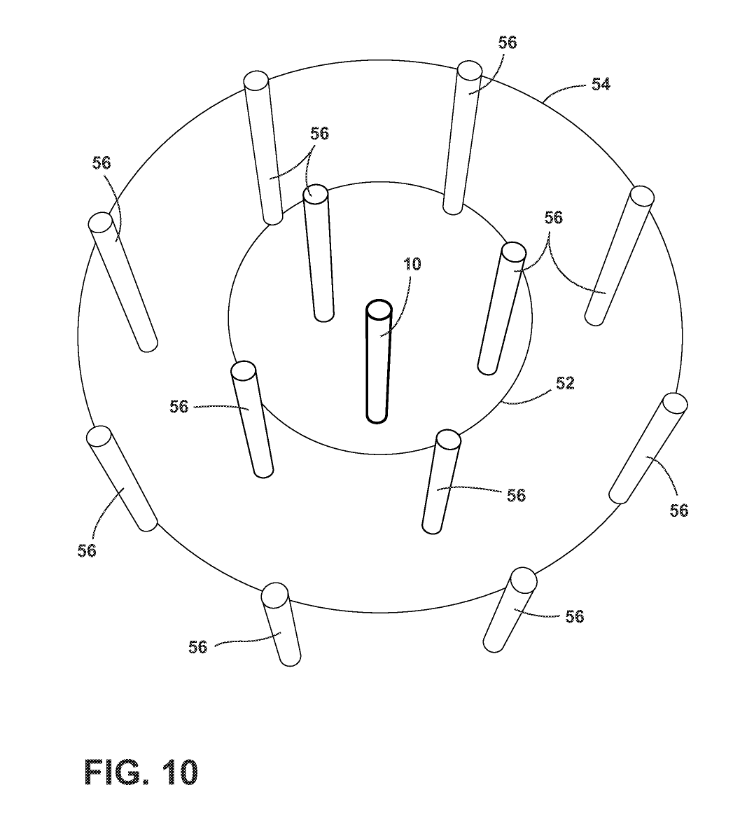

This embodiment contains all the elements of the first embodiment, but adds from 1 to a large number of concentric rings 52, 54 of vertical columns 56. FIG. 10 shows a non-limiting example of 2 concentric rings 52, 54 and a center column 10. The columns 10, 56 are connected by having fluid flow from columns on the outer rings 54 through columns on the inner ring 52 and then to the central column 10. This fluid direction is for heat extraction. The opposite direction is used for heat storage. One embodiment of fluid flow is to have flow to each column controlled based on parameters like column temperature. The preferred embodiment is to have fluid flow from inner 10 to outer columns 56 in the case of heat addition and from outer 56 to inner columns 10 in the case of heat extraction. This embodiment is simpler, more cost effective and automatically returns the hottest or coldest fluid (as is desired). This preferred fluid flow embodiment does not exclude other fluid flow regimes.

This section outlines a thirteenth embodiment of the invention.

This embodiment contains all the elements of the first embodiment, but is designed for tropical climates where the dominant desire is to eliminate heat. The column is used to provide a cool sink into which daytime heat can economically be stored. This is much more efficient than using an air conditioner which must eject heat into the already hot daytime air. The heat stored during the day is ejected from the column by absorption into the surrounding ground. This can be aided by using various nighttime heat ejection methods. A passive one way heat exchanger (e.g. heat pipe) or active heat exchanger (e.g. heat pump) can be placed in the column so that whenever air temperatures drop below column temperature, heat will be ejected. The heat exchanger may be connected to an air-water heat exchanger taking advantage of cooler nighttime temperatures and additional wind often available. The heat exchanger may be connected to a thermally conductive surface designed for night radiative cooling. Where there is sufficient water available, the heat exchanger may be connected to an evaporative cooling system. The one way heat exchanger and active heat exchanger serve to prevent daytime heat from the nighttime cooling devices from entering the column.

This section outlines a fourteenth embodiment of the invention.

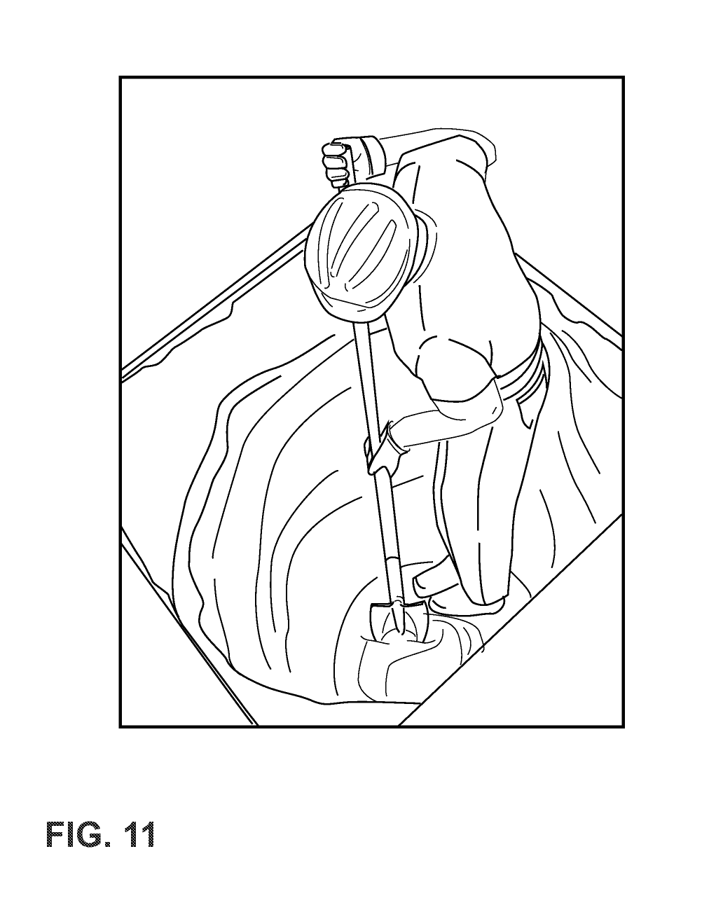

This embodiment contains a method for constructing the columns. The earth is removed by manual digging. This is cost effective and allows the columns to be excavated inside of existing buildings. A non-limiting example of manual excavation from within a building is shown in FIG. 11.

To provide adequate ventilation to diggers, blower systems or vacuum systems may be used. The preferred embodiment is the vacuum system. Any dirt is sucked into the column being excavated and filtered out via the vacuum. This creates a cleaner environment, especially in an existing building. FIG. 3 shows a non-limiting example of a vacuum hose 58 used to provide ventilation.

In this embodiment, column walls are constructed of concrete. To protect the diggers from cave in, column walls are cast in place to form safety supports preventing cave in. Depending on soil conditions and regulations the column walls may be cast every 4′ to 6′ of depth. The column walls may be applied by, but not limited techniques involving to shotcrete, gunite, centrifugally cast shotcrete and centrifugally cast gunite. The preferred embodiment is centrifugally cast gunite. Gunite with appropriate accelerant admixture can set to a safe strength in 5 minutes allowing near continuous digging. As well, gunite application systems do not need to be cleaned out after every use compared to premixed concrete systems like shotcrete. Centrifugal casting allows for very even concrete application and can be controlled from the top of the column. This preferred wall casting technique does not exclude the other techniques previously described.

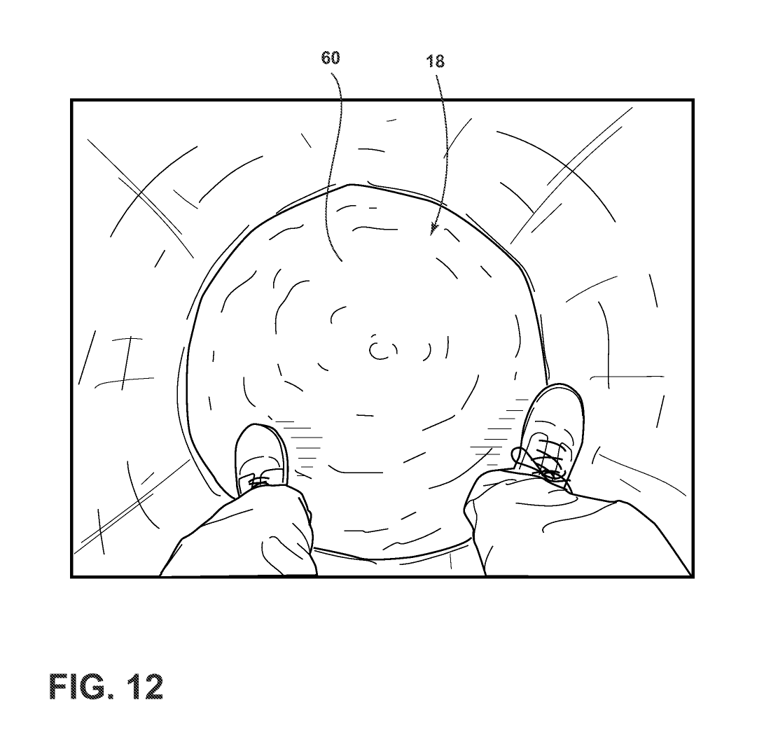

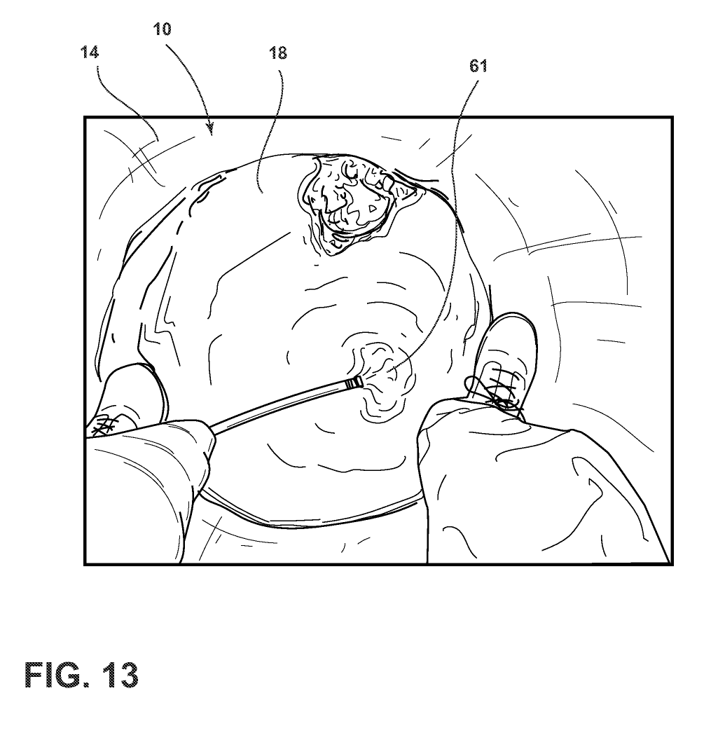

The column bottom may be constructed of standard concrete or underwater concrete. The preferred material bottom embodiment is underwater concrete. The column bottom must make a watertight seal with the column sides. This is especially difficult when the fluid pressure of the filled column is applied to the bottom. Soil under the bottom may shift under the pressure. These shifts may cause cracks in the bottom, or cracks in the interface between bottom and sides. Applying underwater concrete to the bottom and then immediately filling the column with fluid allows the fluid pressure to cause any shifts while the underwater concrete is still fluid. FIG. 12 is a non-limiting example of applying underwater concrete 60 to the column bottom 18. FIG. 13 is a non-limiting example of immediately filling the column with fluid 61 after applying underwater concrete to the column bottom 18. The fluid pressure also forces a watertight fit to the column sides 14. When the underwater concrete cures, a watertight seal results. This preferred bottom concrete material embodiment does not exclude the other techniques previously described.

This section outlines a fifteenth embodiment of the invention.

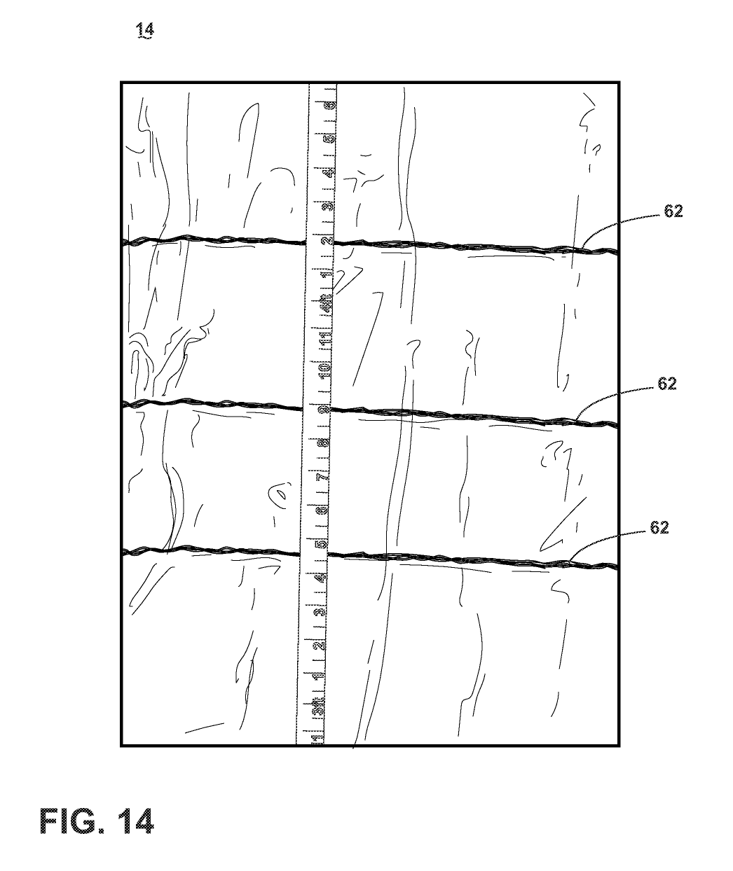

This embodiment contains the elements of the fourteenth embodiment but adds to reinforcement to the column sides to the method. Concrete is very strong in compression, but depending on concrete composition and soil conditions, fluid pressure in the filled column may cause stress in tension. Standard techniques use reinforcing materials that are strong in tension to reinforce the concrete. Reinforcing materials may include, but are not limited to basalt twine, basalt mesh, steel mesh, plastic based meshes, plastic based twines, glass based meshes and glass based twine. The preferred reinforcing material embodiment is basalt twine. The use of a material vulnerable to corrosion like steel requires excessive thickness of concrete to be able to encapsulate the steel and prevent corrosion over decades. Due to the heterogeneity of soil, it is impossible to excavate a column with perfectly formed sides. As a result it, it is nearly impossible to apply a mesh to the inside of the excavated column. As well, the mesh can cause air pockets where it blocks the sprayed concrete. Basalt is very inert, sufficiently strong and has a low embodied energy. The basalt twine is spiraled around the inside of the excavated column with the distance between successive windings decreasing with depth. This increase in windings increases tensile reinforcement in proportion to the increase in fluid pressure as depth increases. The basalt twine is held in place temporarily by staples. The staples are small enough that when they corrode they will not create meaningful voids that would impede thermal conductivity. FIG. 14 is a non-limiting example of basalt twine spiral windings 62 held by staples to the excavated column wall 14. The preferred embodiment material and technique does not exclude the other materials and techniques previously described.

This section outlines a sixteenth embodiment of the invention.

This embodiment contains the elements of the fourteenth embodiment but adds to the method the addition of reinforcing fibers to the applied concrete. Reinforcing fiber materials may include, but are not limited to basalt, plastic, glass and steel. The preferred material is basalt fiber. Steel cannot be used due to corrosion issues. Basalt fibers are very inert, sufficiently strong and have low embodied energy. The preferred embodiment material does not exclude the other materials previously described.

This section outlines a seventeenth embodiment of the invention.

This embodiment contains the elements of the fourteenth embodiment but adds to the method a waterproofing spray applied to the uncured concrete. There are many waterproofing concrete sprays available in different costs, toxicities, water permeabilities and curing effects. The sprays serve to reduce concrete water permeability as well as to slow evaporation during curing. This reduces the potential for concrete cracking. The preferred spray is Kel Prime. This spray is non-toxic and effective. The preferred embodiment spray does not exclude the use of other sprays previously described.

This section outlines a eighteenth embodiment of the invention.

This embodiment contains the elements of the fourteenth embodiment but substitutes machine boring for manual digging in the method. There are many machine boring techniques including, but not limited to augering and drilling. For situations where drilling equipment can be used (e.g. new construction or outdoor columns) augering is the preferred machine boring embodiment. Augers can more cost effectively excavate columns on the order of 40″ wide than other drilling techniques. This preferred embodiment boring technique does not exclude the use of other techniques previously described.

This section outlines a nineteenth embodiment of the invention.

This embodiment contains the elements of the fourteenth embodiment but substitutes vacuum excavation and an air knife for manual digging in the method. For material removal by vacuum excavation both an air knife and water knife may be used. The preferred embodiment is the air knife. Water knives create muddy spoils while air knives do not add water to the excavated material. Dry material is much more useful for use/disposal on site in urban settings. This preferred embodiment excavation technique does not exclude the use of other techniques previously described. Air knives with vacuum excavation allows for rapid digging in most conditions. Extremely compacted clay and very rocky soil are exceptions. The presence of the vacuum eliminates dust on the excavation floor as well as preventing any dust from leaving the column under excavation.

This section outlines a twentieth embodiment of the invention.

This embodiment contains the elements of the fourteenth embodiment but substitutes precast caissons and pressure injected grout to form the column walls in the method. Where accessibility is possible, the column may be dug using precast caissons. The caissons are added to the excavation. As the column depth increases, the caissons fall until there is space to add another caisson on the top of the caisson column. The caissons provide inherent cave-in protection. Once desired column depth is reached, pressurized grout is injected between the outer surface of the caissons and the inner surface of the excavated column. The grout serves to remove any air pockets between the caissons and the earth that would reduce heat transfer capacity between the heat storage fluid and the earth.

This section outlines a twenty first embodiment of the invention.

This embodiment contains the elements of the first embodiment but adds a porous matrix of phase change material (PCM) within the column. With this addition the heat storage liquid may exchange heat with both the ground and the PCM. The matrix may be formed of arrangements including, but not limited to spheres containing PCM arranged in a grid formation, tubes containing PCM, discs containing PCM, rings containing PCM. The preferred embodiment of PCM arrangement is rings of PCM arranged with their centers arranged axially within the column. This arrangement promotes fluid turbulence and helps to break up stratification as well as being able to be easily attached to the central insulated pipe to bottom. This preferred PCM arrangement embodiment does not exclude the use of the other arrangements previously described.

This section outlines a twenty second embodiment of the invention.

This embodiment contains the elements of the first embodiment but packages the column buffer thermal energy storage with a structural piling. Various arrangements include, but are not limited to the column enclosed and coaxial with the piling, column attached to the outside of the piling and parallel to the piling axis. The preferred piling column arrangement is having the column enclosed and coaxial with the piling. The structural material needed to form the piling and give it strength can simultaneously be used to contain the heat storage fluid and there is no need to widen the piling excavation to accommodate external additions. The preferred piling column arrangement embodiment does not exclude the use of the other arrangements previously described.

This section outlines a twenty third embodiment of the invention.

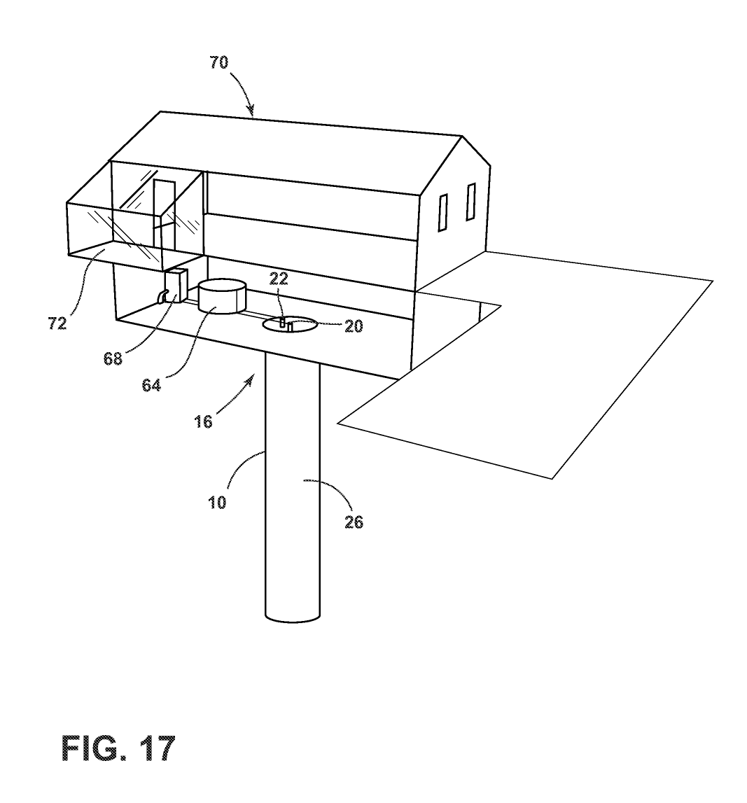

This embodiment contains the elements of the first embodiment but adds an intermediate, highly insulated tank for thermal storage fluid. FIG. 17 provides a non-limiting layout example using the highly insulated tank 64. During periods of high diurnal heat fluctuation like spring and fall in temperate climates, it is desirable to make high temperature heat captured during the day available for heating during the night. While heat from the day is stored and available in the column 10, the temperature is generally reduced making for less effective heating. The same approach can be used for the preservation of cold temperature thermal storage fluid. Cold storage fluid resulting from the extraction of heat at night provides a more efficient cooling during the day. Heat storage fluid exceeding the tank's volume continues on to the column 10. This allows the tank 64 to be charged with the hottest when heat is being stored in the storage fluid by the heat pump, or coolest storage fluid when heat is being recovered from the storage fluid by the heat pump.

As described above, the thermal energy storage system provides an apparatus to store heat or coolness in both water and earth using a column of liquid in the earth where the column has sufficient volumetric liquid thermal capacity to provide daily storage, sufficient daily heat exchange with the earth and accesses sufficient earth thermal capacity to provide storage until the opposite season. The apparatus has watertight, thermally conductive, structurally sufficient walls and bottom. An insulated tube moves liquid to/from the bottom of the apparatus to/from an external heat exchange system. A second tube moves liquid in the opposite direction from the first tube between the top of the apparatus to/from a heat exchange system. Thermal exchange rate between the liquid buffer and an external heat exchange system can occur at rates higher than the capacity of the apparatus to exchange heat with the surrounding earth. Thermal exchange between the liquid buffer and the earth occurs continually even when there is no thermal exchange with the external heat exchange system. In the case of a solar thermal system charging during the day this may more than double the amount of heat exchanged with the earth compared with a bufferless system as exchange with the earth naturally occurs throughout the night. When the apparatus is constructed under a building, much of the heat/cool stored in the earth will radiate up into the building after a time delay providing additional heating/cooling.

Fluctuating sources of heat/cool are best used to supply the present invention, but a heat/cool source may be used. The sources of heat/cool supplied to the apparatus may include, but are not limited to thermal outputs from water to air heat pumps in greenhouses, water to air heat pumps in buildings, solar thermal panels, photovoltaic-thermal solar panels, solar dryers, organic Rankine cycle engines, Kalina cycle engines, Stirling engines, internal combustion engines, biochar kilns, industrial processes, biomass combustion systems, computer server farms, cooling towers, fine wire heat exchangers, standard heat exchangers like domestic hot water radiators and hydronic floors.

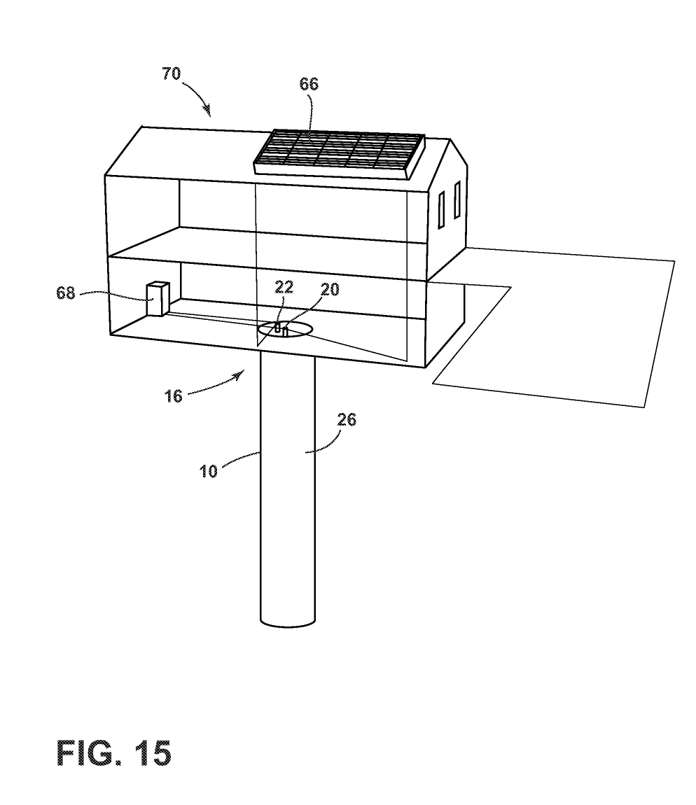

In a non-limiting example, FIG. 15 shows solar panels 66 delivering heat to the column buffer thermal energy storage system 16, while the heat pump 68 also adds heat when air conditioning the house 70. When the house 70 is heated, the heat pump 68 extracts heat from the thermal storage liquid 26 and moves hot air through the house's forced air system.

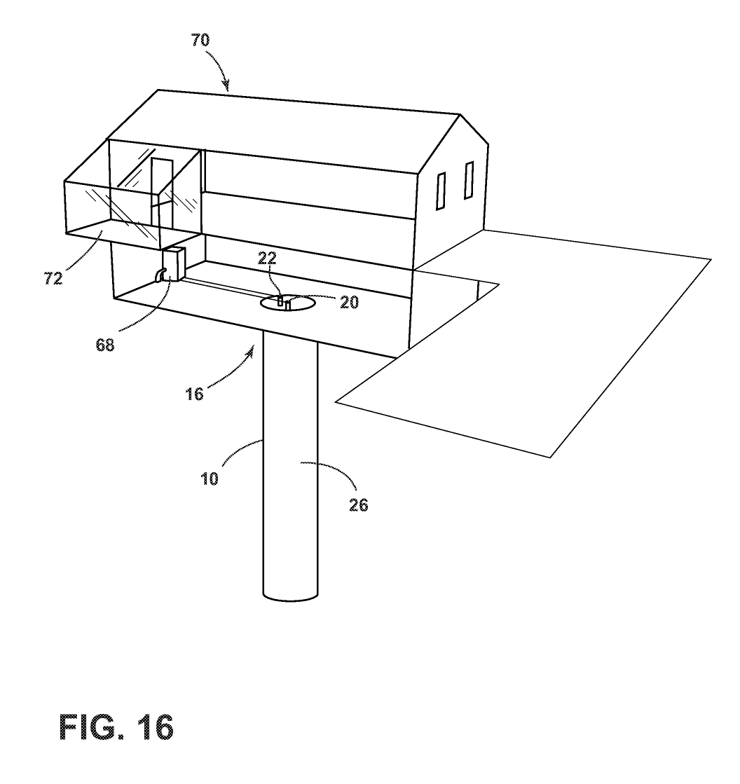

In a further non-limiting example, FIG. 16 shows an attached greenhouse 72 heated and cooled by a water-air heat pump 68. Especially during the summer, there is an excess of heat gathered in the greenhouse 72. The heat pump 68 cools the greenhouse 72 (and house 70) and transfers this heat to the thermal storage fluid in the column buffer thermal energy storage system 16. When the greenhouse 72 or house 70 need heating, the water-air heat pump 68 extracts heat from the thermal storage fluid 26, heats air and moves air through the ducting system to heat the house 70 and greenhouse 72.

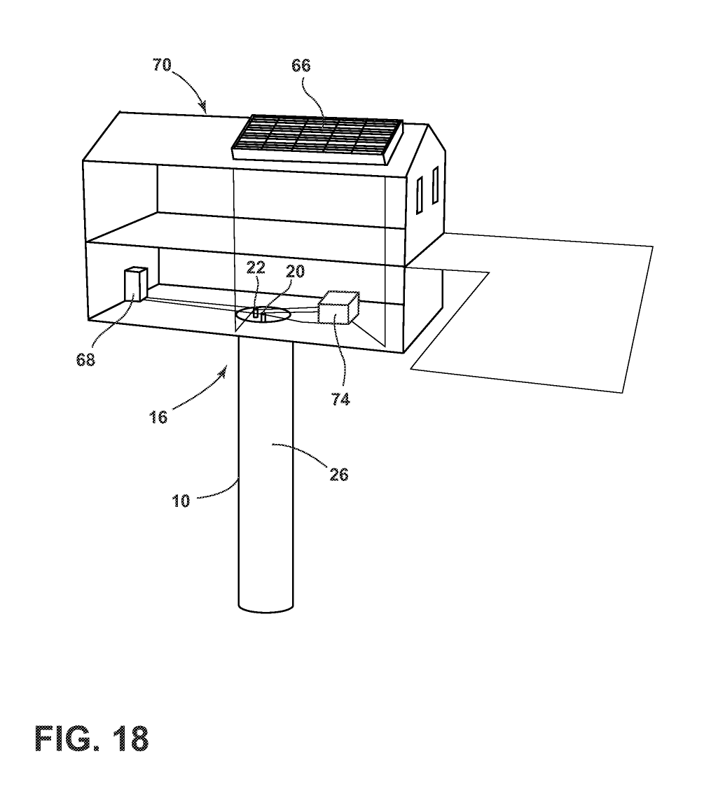

In a further non-limiting example, FIG. 18 shows electrical generation by utilizing the temperature difference between very hot solar heated thermal storage fluid and lower temperature thermal storage fluid in the column buffer thermal energy storage system 16. Various types of electrical generation engines 74 include, but are not limited to Organic Rankine Cycle, Kalina and Stirling.

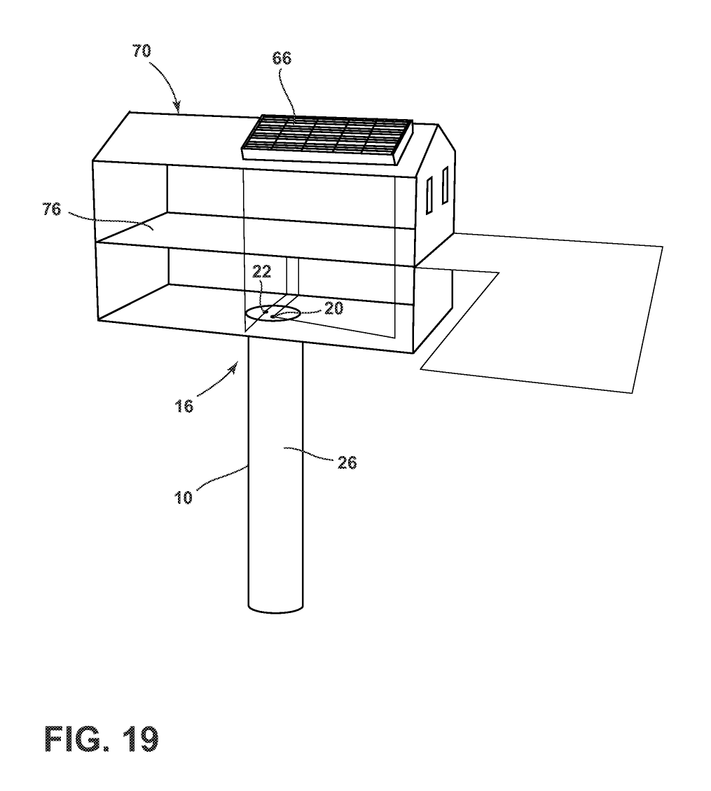

In a further non-limiting example, FIG. 19 shows thermal storage fluid from the column buffer thermal energy storage system 16 directly flowing into and heating an hydronic floor 76.

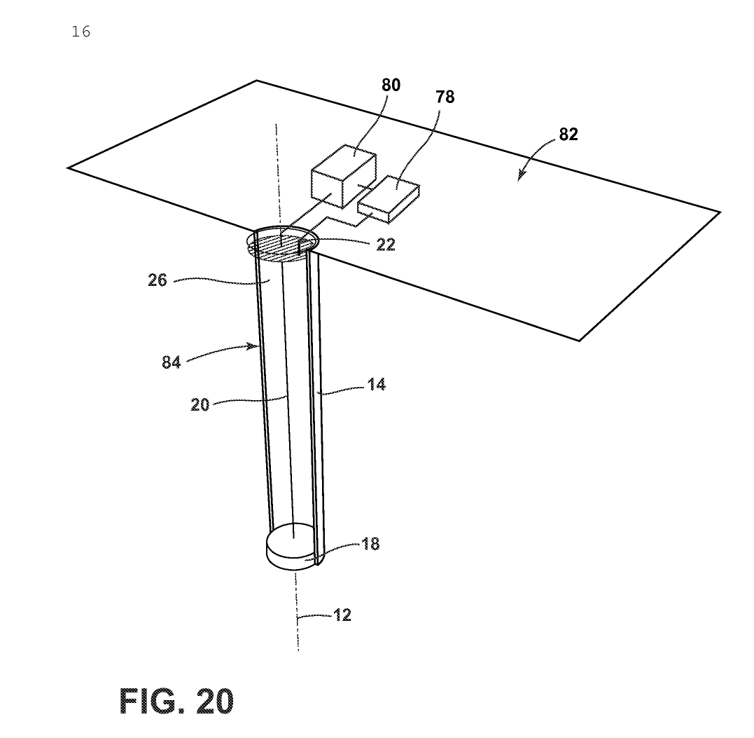

Referring now to FIG. 20, an embodiment of a system for storing thermal energy according to the present invention is shown. The system 16 for storing thermal energy includes an opening into the earth 82 having an axis and a columnar shape. A liner 84 is positioned within and surrounding an interior periphery of the opening. The liner 84 has a leak-proof characteristic and interfaces directly with the earth to allow direct thermal transfer. A liquid 26 is provided within the liner 84 and occupies at least a majority of the volume of an interior of the liner 84. A first conduit (i.e. the pipe to top 22) is fluidly associated with an upper portion of the opening for delivering or withdrawing liquid to the opening adjacent the upper portion of the opening. A second conduit (i.e. the pipe to bottom 20) is fluidly associated with a lower portion of the opening for delivering or withdrawing liquid to the opening adjacent the lower portion of the opening. A fluid movement device 78 and a heat transfer device 80 are fluidly connected between the first conduit 22 and the second conduit 20. The fluid movement device 78 is configured to transport liquid between the first conduit 22 and the second conduits 20. The heat transfer device 80 is fluidly connected to the first conduit 22 and the second conduit 20 and configured to transfer heat to or from the liquid 26.

This invention allows the storage of temperature difference over time periods ranging from daily, weather cycle through annual. Heat may be stored from day to night, from sunny to cloudy periods and from summer to winter. Likewise, cool may be stored over these same periods. The invention is cost effective, inherently safe, can be retrofitted and can operate on a per-residential building basis. This invention benefits society by: reducing or eliminating energy needed to heat in the winter and cool in the summer and allows cost effective installation on a per-residence scale.

The apparatus may have sufficient diameter for manual entry, allowing for easy repair. The apparatus provides superior heat transfer to the soil by using thermally conductive material such as concrete in comparison to existing methods using thermally insulative materials such as PEX. The apparatus provides a liquid thermal capacity that can be rapidly charged/discharged as might be required by the heat supplied by solar thermal panels during daylight. The apparatus provides higher temperature thermal storage liquid when heating is needed, increasing the Coefficient of Performance, thus reducing energy usage.

The apparatus provides a compact heat storage profile so that when placed under a building, the heat loss to the atmosphere is be greatly mitigated by the building itself. This eliminates the need for additional surface insulation over the storage and with the proper geometry allows the heat/cool to reduce the building's energy requirements. When installed inside a building, all elements are contained in the building, so nothing is exposed to weathering, vandalism and the no additional openings in the building skin are created. The much greater heat storage capacity per length allows greatly reduced tubing lengths, costs and pumping energy uses compared existing solutions that involve drilling or trenching.

The systems and methods associated with the invention may provide superior thermal contact with the earth compared to pre-made linings, sleeves etc. The method allows the use of inexpensive transient line source meters to measure soil heat capacitance and conductivity in minutes and at exact depths rather than expensive multi-day tests requiring additional drilling that only provide average heat capacitance and conductivity. The systems and methods associated with the invention may provide superior thermal contact with the earth by being constructed of a material that does not pull away from soil during heating and cooling. The systems and methods associated with the invention allows for construction inside of an existing building without requiring large or expensive drilling/excavating equipment.

The present invention provides systems and methods to excavate and construct a watertight column in the earth where the column sides and bottom are made with a thermally conductive material, the sides provide excellent thermal contact with the earth, the sides provide sufficient hoop strength to resist the pressure of liquid in the filled column, where the bottom has adequate strength to resist the downward pressure of liquid in the filled column, where the bottom is joined in a watertight manner to the sides so that water does not leak in or out, where the bottom is constructed so that the pressure of the filled liquid column does not cause settling, cracking or separation.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

What is claimed is:

1. A system for storing thermal energy comprising:
at least one opening into the earth having an axis and a columnar shape;
a liner positioned within and surrounding an interior periphery of the at least one opening and having a leak-proof characteristic, wherein the liner interfaces directly with the earth to allow direct thermal transfer;
a liquid provided within the liner which occupies at least a majority of the volume of an interior of the liner;
a first conduit fluidly associated with an upper portion of the at least one opening for delivering or withdrawing liquid to the at least one opening adjacent the upper portion of the at least one opening;
a second conduit fluidly associated with an lower portion of the at least one opening for delivering or withdrawing liquid to the at least one opening adjacent the lower portion of the at least one opening;
at least one fluid movement device fluidly connected between the first and second conduits configured to transport liquid between the first and second conduits; and
at least one heat transfer device fluidly connected to the first conduit and the second conduit configured to transfer heat to or from the liquid.

2. The system of claim 1 wherein the axis of the at least one opening is generally perpendicular to a surface of the earth.

3. The system of claim 1 wherein the system is associated with a structure to which heat from the system is to be delivered to or withdrawn from.

4. The system of claim 3 wherein the structure is at least one of a building, a residence, an office building, an industrial center, a greenhouse, a bridge, a roadway, a driveway, a pool, an icemelt system, a hydronically heated floor or a sidewalk.

5. The system of claim 1 wherein the liquid is water.

6. The system of claim 1 wherein the liner covers the sides and bottom of the at least one opening.

7. The system of claim 1 wherein the liner is formed from at least one of concrete, shotcrete, gunite, underwater-curable concrete.

8. The system of claim 1 wherein the liner is reinforced by spirally-wrapped twine.

9. The system of claim 1 wherein a plurality of baffles is spaced vertically along the axis of the at least one opening, each of the plurality of baffles comprises a body generally shaped to conform with the interior of the liner and define at least one passageway between a periphery of the baffle and the interior of the liner.

10. The system of claim 9 wherein the vertical spacing of the baffles is regular.

11. The system of claim 9 wherein the periphery of each of the plurality of baffles is crenelated.

12. The system of claim 9 wherein the second conduit extends downwardly into the at least one opening from the upper portion thereof, in general register with a central portion thereof and through a central opening in each of the baffles.

13. The system of claim 1 wherein the bottom of the second conduit is fluidically connected to at least one laterally extending conduit which has at least one distal opening allowing the liquid being delivered or withdrawn from the distal opening to be delivered or withdrawn so as to induce rotation of the liquid reservoir about the axis of the at least one opening.

14. The system of claim 1 wherein at least one of the first and second conduits is thermally insulated.

15. The system of claim 1 wherein at least one one-way heat transfer device is configured to transport heat upwardly to an external heat exchanger.

16. The system of claim 1 wherein the first conduit is fluidly interconnected with the second conduit to form a closed loop within the at least one opening.

17. The system of claim 1 wherein the fluid movement contained by the first and the second conduits are contained within a common housing.

18. The system of claim 1 and further comprising a generator operably connected to the fluid passing through the heat exchanger to generate electricity from the liquid in the system via at least one of the Organic Rankine cycle, the Kalina cycle or the Stirling engine.

19. The system of claim 1 wherein the at least one fluid movement device and the at least one heat transfer device are contained within a common device housing.

20. A method of installing a system for storing thermal energy, the method comprising the steps of:
excavating an opening having a column shape and an axis into the earth;
installing a leak-proof liner around an interior periphery of the opening;
filling the at least one opening with a liquid;
plumbing a first conduit to withdraw or deliver liquid to an upper portion of the opening;
plumbing a second conduit to withdraw or deliver liquid to a lower portion of the opening; and
fluidly interconnecting remote ends of the first and second conduits to a fluid movement device and a heat transfer device to allow for heating, cooling and flow of the liquid in the at least one opening between the upper and lower portions thereof.

21. The method of claim 20 wherein the liner is extended at pace with the excavation using shotcrete or gunite to allow the liner to be leak-proof, interfaced directly with the earth to allow direct thermal transfer and to provide safety protection from cave-in while excavating.

22. A method for storing thermal energy, the method comprising the steps of:
providing at least one opening into the earth having an axis and a columnar shape;
lining an interior periphery and bottom of the at least one opening with a leak-proof material;
filling the interior of the at least one opening with liquid;
withdrawing liquid from one of the upper portion or the lower portion of the at least one opening;
using the withdrawn liquid to exchange heat; and
returning the withdrawn liquid to the other of the upper portion or the lower portion of the at least one opening.
